(19) United States
(12) Patent Application Publication
(10) Pub. No.: US 2025/0105358 A1
(43) Pub. Date: Mar. 27, 2025

(54) SECONDARY BATTERIES WITH PROTECTIVE LAYER CONTAINING (PER)FLUOROELASTOMER

(71) Applicant: SYENSQO SA, Brussels (BE)

(72) Inventors: Maxime Guillaume, Bouge (BE); Didier Grandfils, Bruxelles (BE); Luca Merlo, IXELLES (BE); Ji-Ae Choi, Gyeonggi-do (KR); Vincent Finsy, Halle (BE)

(73) Assignee: SYENSQO SA, Brussels (BE)

(21) Appl. No.: 18/707,503

(22) PCT Filed: Nov. 2, 2022
(86) PCT No.: PCT/EP2022/080495

§ 371 Date: May 3, 2024

(30) Foreign Application Priority Data
Nov. 4, 2021 (EP) 21206360.6

(51) Int. Cl. H01M 10/0569; H01M 4/02; H01M 4/04; H01M 4/505; H01M 4/525; H01M 4/62; H01M 10/052; H01M 10/0568

(52) U.S. Cl. CPC H01M 10/0569; H01M 4/0409; H01M 4/505; H01M 4/525; H01M 4/62; H01M 10/052; H01M 10/0568; H01M 2004/027; H01M 2300/0034

(57) ABSTRACT

The present invention relates to a secondary battery comprising a) a negative electrode comprising an alkali metal; b) a protective layer on a surface of the negative electrode; and c) a liquid electrolyte comprising a solvent mixture and at least one metal salt, wherein the protective layer comprises at least one (per)fluoroelastomer, and the solvent mixture comprises i) at least one fluorinated ether compound and ii) at least one non-fluorinated ether compound. The present invention also relates to use of a (per)fluoroelastomer as a protective layer for a negative electrode comprising an alkali metal in a secondary battery, wherein the secondary battery comprises a solvent mixture comprising i) at least one fluorinated ether compound and ii) at least one non-fluorinated ether compound.

### CROSS-REFERENCE TO RELATED APPLICATION

This application claims priority to European patent application No. 21206360.6 filed on Nov. 4, 2021, the whole content of this application being incorporated herein by reference for all purposes.

### TECHNICAL FIELD

The present invention relates to a secondary battery comprising a) a negative electrode comprising an alkali metal; b) a protective layer on a surface of the negative electrode; and c) a liquid electrolyte comprising a solvent mixture and at least one metal salt, wherein the protective layer comprises at least one (per)fluoroelastomer, and the solvent mixture comprises i) at least one fluorinated ether compound and ii) at least one non-fluorinated ether compound. The present invention also relates to use of a (per)fluoroelastomer as a protective layer for a negative electrode comprising an alkali metal in a secondary battery, wherein the secondary battery comprises a solvent mixture comprising i) at least one fluorinated ether compound and ii) at least one non-fluorinated ether compound.

### BACKGROUND OF THE INVENTION

Lithium ion batteries have retained a dominant position in the market of rechargeable energy storage devices due to their many benefits comprising light-weight, reasonable energy density, and good cycle life. Nevertheless, current lithium ion batteries still suffer from relatively low energy density with respect to the required energy density, which continuously increases to meet the needs for high power applications such as electrical vehicles, hybrid electrical vehicles, grid energy storage (also called large-scale energy storage), etc.

Employing lithium metal as the negative electrode has been known since the 1970s, because of the favourable characteristics of lithium metal resulting from its low redox potential and high specific capacity. Such a lithium metal battery usually uses conventional liquid electrolytes such as a carbonate-based electrolyte and/or an ether-based electrolyte having a low viscosity and a high ionic conductivity. These liquid electrolytes decompose to make a passivation layer at the beginning of the cycles, which will result in the dendrite growth, and also further side reactions between the electrolyte and the deposited reactive lithium ions. These have been the critical issues to block the commercialization of lithium metal batteries.

The basic requirements of a suitable electrolyte for lithium metal batteries are the same as conventional liquid electrolytes for lithium ion batteries, i.e., high ionic conductivity, low melting and high boiling points, (electro)chemical stability and also safety. In addition to said basic requirements, the suitable electrolyte for lithium metal batteries should provide solutions to the drawbacks as above mentioned.

As one of diverse research efforts with a purpose to reduce or suppress the lithium dendrite formation and to improve the cycling performance of the lithium metal batteries, the use of a solid electrolyte has been considered instead of a liquid electrolyte. For example R. Sudo et al. describe in Solid State Ionics, 262, 151 (2014) the use of Al-doped Li₇La₃Zr₂O₁₂ as a solid electrolyte in an electrochemical cell comprising a Li metal as negative electrode. However, lithium dendrites were still observed.

D. Aurbach et al. in Solid State Ionics, 148, 405 (2002) and H. Ota et al. in Electrochimica Acta, 49, 565 (2004) report that additives such as CO₂, SO₂, and vinylene carbonate help in improving the stability of the passivation layer. However, these additives are consumed during the operation of the cell. Thus, they cannot be a long-term solution against the dendrite formation.

In addition, there have been various approaches with the same purpose, consisting of modifying the composition of the liquid electrolyte.

For example, the use of a liquid electrolyte with a high lithium salt concentration of lithium bis(trifluoromethane sulfonyl)imide (LiTFSI) in dimethoxyethane (DME) and 1,3-dioxolane (DOL) (1:1 vol:vol) for suppressing lithium dendrite formation has been described by L. Suo et al. in Nature Communications, DOI:10.1038/ncomms2513 (2013).

H. Wang et al. report in ChemElectroChem, 2, 1144 (2015) that a cell containing lithium metal as the negative electrode and a solvated ionic liquid of tetraglyme (G4) and lithium bis(fluorosulfonyl)imide (LiFSI) as the electrolyte exhibits excellent cycling performance.

US 2007/054186 A1 (3M Innovative Properties Company) discloses an electrolyte composition for electrochemical devices, which contains a solvent composition comprising a cyclic carbonic acid ester, such as ethylene carbonate, and at least one fluorine-containing solvent having a boiling point of at least 80° C., such as a hydrofluoroether of particular formulae, and at least one electrolyte salt, such as lithium hexafluorophosphate (LiPF₆).

In particular, EP3118917 B1 (Samsung Electronics Co., Ltd.) discloses an electrolyte specific for a lithium metal battery, comprising a non-fluorine substituted ether capable of solvating lithium ions, a fluorine substituted ether, which is a glyme-based solvent with a particular formula, and a lithium salt, wherein the amount of the fluorine substituted ether is greater than an amount of the non-fluorine substituted ether.

There still exists, however, the outstanding needs to provide an electrolyte for a lithium metal battery having improved cell performance including safety, while minimizing the dendrite growth and the side reactions between the liquid electrolyte and the negative electrode.

### SUMMARY OF THE INVENTION

The present invention relates to a secondary battery comprising a) a negative electrode comprising an alkali metal; b) a protective layer on a surface of the negative electrode; and c) a liquid electrolyte comprising a solvent mixture and at least one metal salt, wherein the protective layer comprises at least one (per)fluoroelastomer, and the solvent mixture comprises i) at least one fluorinated ether compound and ii) at least one non-fluorinated ether compound.

The present invention also relates to use of a (per)fluoroelastomer as a protective layer for a negative electrode comprising an alkali metal in a secondary battery, wherein the secondary battery comprises a solvent mixture comprising i) at least one fluorinated ether compound and ii) at least one non-fluorinated ether compound.

It was surprisingly found by the inventors that the above-mentioned technical problems can be solved by using a (per)fluoroelastomer as a protective layer for the negative electrode comprising an alkali metal in a secondary battery, wherein the secondary battery comprises a solvent mixture comprising i) at least one fluorinated ether compound and ii) at least one non-fluorinated ether compound, which is supported by the excellent capacity retention. In particular, the present invention was made by conceiving the combination of localized high concentration electrolyte (LHCE) and a protective layer based on a fluoroelastomer on a surface of the negative electrode, notably Li metal, which resulted in an excellent capacity retention (evaluated as number of cycles at 80% of capacity). That is, it was found that the combination of the fluoroelastomer as a protective layer and the LHCE provides an outstanding cycling performance.

### DETAILED DESCRIPTION OF THE INVENTION

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

As used herein, the terminology “(Cₙ-Cₘ)” in reference to an organic group, wherein n and m are integers, respectively, indicates that the group may contain from n carbon atoms to m carbon atoms per group.

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups.

The term “aliphatic group” includes organic moieties characterized by straight or branched-chains, typically having between 1 and 18 carbon atoms. In complex structures, the chains may be branched, bridged, or cross-linked. Aliphatic groups include alkyl groups, alkenyl groups, and alkynyl groups.

In the context of the present invention, the term “percent by weight” (wt %) indicates the content of a specific component in a mixture, calculated as the ratio between the weight of the component and the total weight of the mixture. When referred to the recurring units derived from a certain monomer in a (co)polymer, percent by weight (wt %) indicates the ratio between the weight of the recurring units of such monomer over the total weight of the (co)polymer.

Unless otherwise specified, in the context of the present invention the amount of a component in a composition is indicated as the ratio between the volume of the component and the total volume of the composition multiplied by 100, i.e., % by volume (vol %).

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C.

As used herein, the term “molar concentration” or “molarity” is a measure of the concentration of a chemical species, in particular of a solute in a solution, in terms of the amount of substance per unit volume of solution. The most commonly used unit for molarity is the number of moles per liter, having the unit of mol/L. A solution with a concentration of 1 mol/L is indicated as 1 molar and designated as 1 M.

In the present invention, the term “Coulombic efficiency”, also known as Faraday efficiency, is intended to denote the charge efficiency by which electrons are transferred in a system facilitating an electrochemical reaction, i.e., batteries and it corresponds to the ratio of the total charge extracted from the battery to the total charge put into the battery over a full cycle. In addition, the Coulombic efficiency (%) is calculated by dividing the discharge capacity of each cycle by the charge capacity of each cycle, multiplied by 100.

In the present invention, the term “secondary battery” or “rechargeable battery” is intended to denote a type of electrical battery which can be charged, discharged and recharged many times.

As used herein, the term “lithium metal battery” is intended to denote a secondary battery that have metallic lithium as negative electrode.

The term “amorphous” is hereby intended to denote a polymer having a heat of fusion of less than 5 J/g, preferably of less than 3 J/g, and more preferably of less than 2 J/g as measured by Differential Scanning Calorimetry (DSC) at a heating rate of 10° C./min according to ASTM D-3418-08.

The term “semi-crystalline” is hereby intended to denote a polymer having a heat of fusion of from 10 to 90 J/g, preferably of from 30 to 60 J/g, and more preferably of from 35 to 55 J/g, as measured according to ASTM D3418-08.

The term “alkali metals” is hereby intended to denote the chemical elements of lithium (Li), sodium (Na), potassium (K), rubidium (Rb), caesium (Cs) and francium (Fr), preferably Li, Na and K, and more preferably Li. In the present invention, the alkali metal also comprises alloys.

It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention relates to a secondary battery comprising
a) a negative electrode comprising an alkali metal;
b) a protective layer on a surface of the negative electrode; and
c) a liquid electrolyte comprising a solvent mixture and at least one metal salt, wherein the protective layer comprises at least one (per)fluoroelastomer, and the solvent mixture comprises i) at least one fluorinated ether compound and ii) at least one non-fluorinated ether compound.

In one embodiment, the alkali metal is Li, Na or K.

In a preferred embodiment, the alkali metal is Li.

In another embodiment, the alkali metal is a lithium alloy, preferably Li—Si, Li—Sn, Li—Ge, Li—Si, or Li—B.

An electrode in an electrochemical cell is referred to as either an anode or cathode. The anode is defined as the electrode where electrons leave the cell and oxidation occurs, and the cathode as the electrode where electrons enter the cell and reduction occurs. Each electrode may become either the anode or the cathode depending on the direction of current through the cell. A bipolar electrode is an electrode that functions as the anode of one cell and the cathode of another cell. When a cell is being charged, the anode becomes the positive electrode and the cathode becomes the negative electrode, while when a cell is being discharged, the anode becomes the negative electrode and the cathode becomes the positive electrode.

In the present invention, the term “negative electrode” is intended to denote, in particular, the electrode of an electrochemical cell, where oxidation occurs during discharging.

In the present invention, the term “positive electrode” is intended to denote, in particular, the electrode of an electrochemical cell, where reduction occurs during discharging.

In the present invention, the nature of the “current collector” depends on whether the electrode thereby provided is either a cathode or anode. Should the electrode of the invention be a cathode, the current collector typically comprises, preferably consists of at least one metal selected from the group consisting of Aluminium (Al), Nickel (Ni), Titanium (Ti), and alloys thereof, preferably Al. Should the electrode of the invention be an anode, the current collector typically comprises, preferably consists of at least one metal selected from the group consisting of Lithium (Li), Sodium (Na), Zinc (Zn), Magnesium (Mg), Copper (Cu) and alloys thereof, preferably Cu.

In the present invention, the term “anode-less lithium ion battery” is intended to denote, in particular, the lithium ion battery which does not include an anode electro-active material on the anode current collector when the battery is assembled and before the first charge. After the first charge, the anode-less lithium ion battery comprises either a lithium metal thin layer or a lithium alloy thin layer on the anode current collector. That is, while the anode-less lithium ion battery has a negative electrode, the term “anode-less” is used because when manufactured a distinct anode electro-active material is not present in the lithium ion battery.

For the purposes of this invention, the term “fluoroelastomer” is intended to designate a fluoropolymer resin serving as a base constituent for obtaining a true elastomer, said fluoropolymer resin comprising more than 10 wt %, preferably more than 30 wt %, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers are in general amorphous products or products having a low degree of crystallinity (crystalline phase less than 20 vol %) and a glass transition temperature (Tg) below room temperature. In most cases, the fluoroelastomer has advantageously a Tg below 10° C., preferably below 5° C., more preferably 0° C., even more preferably below −5° C.

In one embodiment, the (per)fluoroelastomer is a vinylidene-fluoride based fluoroelastomer comprising recurring units derived from vinylidene fluoride (VDF) and from at least one additional (per)fluorinated monomer different from VDF.

The (per)fluoroelastomer typically comprises at least 15 mol %, preferably at least 20 mol %, more preferably at least 35 mol % of recurring units derived from VDF, with respect to all recurring units of the fluoroelastomer.

The (per)fluoroelastomer typically comprises at most 85 mol %, preferably at most 80 mol %, more preferably at most 78 mol % of recurring units derived from VDF, with respect to all recurring units of the fluoroelastomer.

Non-limitative examples of suitable (per)fluorinated monomers different from VDF are notably:
(a) C₂-C₈ perfluoroolefins, such as tetrafluoroethylene (TFE) and hexafluoropropylene (HFP);
(b) hydrogen-containing C₂-C₈ olefins different from VDF, such as vinyl fluoride (VF), trifluoroethylene (TrFE), perfluoroalkyl ethylene of formula CH₂=CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂=CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂=CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

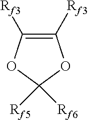

wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃; and
(g) (per)fluoro-methoxy-vinylethers (MOVE, hereinafter) having formula:

CFX₂═CX₂OCF₂OR″_{f}
wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂=F, H; preferably X₂ is F and R″_{f} is —CF₂CF₃ (MOVE1); —CF₂CF₂OCF₃ (MOVE2); or —CF₃ (MOVE3).

Generally, the (per)fluoroelastomer comprises recurring units derived from VDF and C₂-C₈ perfluoroolefins. In a preferred embodiment, said C₂-C₈ perfluoroolefins are TFE and HFP.

The (per)fluoroelastomer may optionally further comprise recurring units derived from one or more than one monomer free from fluorine (hydrogenated monomer, hereinafter). Examples of hydrogenated monomers are notably C₂-C₈ non-fluorinated olefins (01), in particular C₂-C₈ non-fluorinated alpha-olefins (01), including ethylene, propylene, 1-butene; diene monomers; styrene monomers; C₂-C₈ non-fluorinated alpha-olefins (01), and more particularly ethylene and propylene, will be selected for achieving increased resistance to bases.

Optionally, the (per)fluoroelastomer may comprises recurring units derived from at least one bis-olefin [bis-olefin (OF)] having general formula:

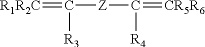

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical, e.g. as described in EP 661304 A (AUSIMONT SPA).

The bis-olefin (OF) is preferably selected from the group consisting of those complying with formulae (OF-1), (OF-2) and (OF-3):

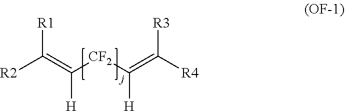

wherein j is an integer between 2 and 10, preferably between 4 and 8, and R1, R2, R3, R4, equal or different from each other, are H, F or C₁₋₅ alkyl or (per)fluoroalkyl group;

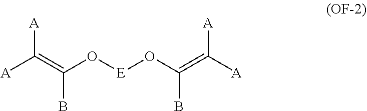

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C=CF—O—(CF₂)₅—O—CF=CF₂;

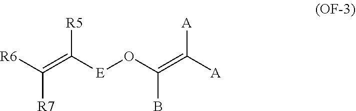

wherein E, A and B have the same meaning as above defined; R5, R6, R7, equal or different from each other, are H, F or C₁₋₅ alkyl or (per)fluoroalkyl group.

The (per)fluoroelastomers suitable in the compositions of the invention may comprise, in addition to recurring units derived from VDF, TFE and HFP, one or more of the followings:
recurring units derived from at least one bis-olefin [bis-olefin (OF)] as above detailed;
recurring units derived from at least one (per)fluorinated monomer different from VDF, TFE and HFP; and
recurring units derived from at least one hydrogenated monomer.

Among specific monomer compositions of (per)fluoroelastomers suitable for the purpose of the invention, mention can be made of fluoroelastomers having the following monomer compositions (in mol %):
(i) vinylidene fluoride (VDF) 35-85%, hexafluoropropene (HFP) 10-45% tetrafluoroethylene (TFE) 0.1-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50% tetrafluoroethylene (TFE) 0-20%, bis-olefin (OF) 0-5%;
(iii) vinylidene fluoride (VDF) 20-30%, C₂-C₈ non-fluorinated olefins (01) 10-300%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 45-65%, C₂-C₈ non-fluorinated olefins (01) 20-55%, vinylidene fluoride (VDF) 0.1-30%, bis-olefin (OF) 0-5%,
(v) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(vi) vinylidene fluoride (VDF) 35-85%, fluorovinyl ethers (MOVE) 5-40% perfluoroalkyl vinyl ethers (PAVE) 0-30%, tetrafluoroethylene (TFE) 0-40% hexafluoropropene (HFP) 0-30%, bis-olefin (OF) 0-5%.

Even more preferably, a monomer composition of (per)fluoroelastomers suitable for the purpose of the invention, is as follows (in mol %): vinylidene fluoride (VDF) 50-80% hexafluoropropene (HFP) 15-25%, tetrafluoroethylene (TFE) 5-25%.

In the present invention, the term “protective layer” is intended to denote, in particular, a layer coated on a surface of an alkali metal in a negative electrode, which reduces the contact area between the electrolyte and the alkali metal, for instance, lithium metal, thus mitigating the side reactions. In contrast to the solid electrolyte interphase (SEI) layer formed by the side reaction inside the battery, the protective layer can be considered as a preformed, artificial SEI layer. The composition of the coating materials can be optimized to obtain better performances, e.g., ionic conductivity, mechanical properties and permeability of the solvent.

In one embodiment, the negative electrode comprises Li metal and a current collector, wherein Li metal has at least two surfaces, i.e., one applied to the current collector and the other facing the protective layer according to the present invention.

In the present invention, the term “electro-active material” is intended to denote an electro-active material that is able to incorporate or insert into its structure and substantially release therefrom lithium ions during the charging phase and the discharging phase of a battery.

In the case of forming a positive electrode for the secondary battery according to the present invention, the electro-active material of a positive electrode is not particularly limited. It may comprise a composite metal chalcogenide of formula LiMQ₂, wherein M is at least one metal selected from transition metals such as Co, Ni, Fe, Mn, Cr, and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1), and spinel-structured LiMn₂O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂.

As an alternative, still in the case of forming a positive electrode for an anode-less lithium ion battery, the electro-active compound of a positive electrode may comprise a lithiated or partially lithiated transition metal oxyanion-based electro-active material of formula M₁M₂(JO₄)_{f}E_{1-f}, wherein M₁ is lithium, which may be partially substituted by another alkali metal representing less that 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electro-active material of a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro-active material is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In a preferred embodiment, the electro-active material of a positive electrode is selected from the group consisting of LiMQ₂, wherein M is at least one metal selected from Co, Ni, Fe, Mn, Cr and V and Q is 0 or S; LiNiₓCo₁₋ₓO₂ (0<x<1); spinel-structured LiMn₂O₄; lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), and LiFePO₄.

In one embodiment, at least one electro-active compound of a positive electrode according to the present invention is loaded onto the current collector to have an areal capacity between 1.0 mAh/cm² and 10.0 mAh/cm², preferably between 2.0 mAh/cm² and 8.0 mAh/cm².

In another embodiment, at least one electro-active compound of a positive electrode according to the present invention is loaded onto the current collector to have an areal capacity between 4.0 mAh/cm² and 7.0 mAh/cm².

In the present invention, the expression “thickness of the electrode” is intended to denote a total combined thickness of the current collector and the electro-active material layer.

In one embodiment, the thickness of the positive electrode according to the present invention is between 40 μm and 150 μm, preferably between 50 μm and 120 μm, and more preferably between 50 μm and 100 μm.

In one embodiment, the thickness of the negative electrode according to the present invention is between 0 μm and 200 μm, preferably between 20 μm and 150 μm, and more preferably between 20 μm and 100 μm.

In the present invention, the solvent mixture comprises i) at least one fluorinated ether compound and ii) at least one non-fluorinated ether compound.

In the present invention, the term “fluorinated ether compound” is intended to denote an ether compound, wherein at least one hydrogen atom is replaced by fluorine. One, two, three or a higher number of hydrogen atoms may be replaced by fluorine.

In one embodiment, the fluorinated ether compound comprises fluorinated mono-ether compounds, fluorinated di-ether compounds and fluorinated tri-ether compounds.

In another embodiment, the fluorinated ether compound according to the present invention is an aliphatic compound.

In a preferred embodiment, the fluorinated ether compound has a chemical formula of CₐF_{b}H_{c}O_{d}, wherein d is an integer from 1 to 3, a is an integer from 3 to 10, preferably from 4 to 7, and 2*(a+1)=b+c.

In a more preferred embodiment, the fluorinated ether compound is selected from the group consisting of:
i) 1,1,2,2-tetrafluoroethyl-2,2,3,3-tetrafluoropropyl ether (TTE), 1,1,3,3-tetrafluoro-1-(1,1,2,2-tetrafluoroethoxy) propane, 1,1,1,3,3-pentafluoro-3-(2,2,2-trifluoroethoxy) propane, 1,1,1,3,3-pentafluoro-3-(1,1,3,3,3-pentafluoropropoxy)propane, 1,1′-oxybis(1,1,2,2-tetrafluoroethane), 1,1,1,3,3-pentafluoro-3-methoxy-2-(trifluoromethyl) propane, 1,1,1,3,3-pentafluoro-3-(fluoromethoxy)-2-(trifluoromethyl)propane, 2,2-difluoro-2-methoxy-1,1-bis(trifluoromethyl)ethane, 2-(ethoxy difluoromethyl)-1,1,1,3,3,3-hexafluoropropane, 2-(difluoropropoxy methyl)-1,1,1,3,3,3-hexafluoropropane, 1,1-bis(difluoromethoxy)-1,2,2,2-tetrafluoroethane, 1,1,2,2-tetrafluoro-3-(1,1,2,2-tetrafluoroethoxy) propane, 1-(2,2-difluoroethoxy)-1,1,2,3,3,3-hexafluoropropane, 1,1,2,2,3-pentafluoro-3-(1,1,2,2-tetrafluoroethoxy)propane, 1-(3,3-difluoropropoxy)-1,1,2,3,3,3-hexafluoropropane, 1-[difluoro(1,1,2,2-tetrafluoroethoxy)methoxy]-1,1,2,2,2-pentafluoroethane, 1,1′-[(difluoromethylene)bis(oxy)]bis(1,1,2,2,2-pentafluoroethane), 1,1,1,3,3,3-hexafluoro-2-fluoromethoxymethoxy propane, pentafluoro[1,2,2,2-tetrafluoro-1-(trifluoromethoxy)ethoxy]ethane, 1,1,2,3,3-pentafluoro-1,3-dimethoxypropane, 1,1,2,2,3,3-hexafluoro-1-methoxy-3-trifluoromethoxypropane, 1,1′-[(difluoromethylene)bis(oxy)]-bis(2,2,2-trifluoroethane), 1,2-bis(difluoromethoxy)-1,1,2,2-tetrafluoroethane, [2-(difluoromethoxy)-1,1,2,2-tetrafluoroethoxy]difluoromethane, 1-[difluoro(trifluoromethoxy)methoxy]-1,1,2,2-tetrafluoro-2-methoxyethane, 1-(difluoromethoxymethoxy)-1,1,2,2-tetrafluoro-2-(trifluoromethoxy)ethane, 1-[(difluoromethoxy)difluoromethoxy]-1,1,2,2-tetrafluoro-2-methoxyethane, and 1-(difluoromethoxy)-2-[(difluoromethoxy)difluoromethoxy]-1,1,2,2-tetrafluoroethane;
ii) chemical compounds represented by the general formula (A),

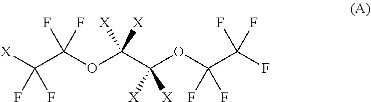

wherein X is H or F; and
iii) mixtures thereof.

In a even more preferred embodiment, the fluorinated ether compound comprises 1,1,2,2-tetrafluoroethyl-2,2,3,3-tetrafluoropropyl ether (TTE) and CF₂HCF₂—OCH₂CH₂O—CF₂CF₂H.

In the present invention, the term “non-fluorinated ether compound” is intended to denote an ether compound, wherein no fluorine atom is present.

Non-limitative examples of suitable non-fluorinated ether compounds according to the present invention include, notably, the followings:
aliphatic, cycloaliphatic or aromatic ether, more particularly, dibutyl ether, dipentyl ether, diisopentyl ether, dimethoxyethane (DME), 1,3-dioxolane (DOL), tetrahydrofuran (THF), 2-methyltetrahydrofuran, and diphenyl ether;
glycol ethers, such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, diethylene glycol dimethyl ether (DEGME), ethylene glycol diethyl ether, diethylene glycol diethyl ether (DEGDEE), tetraethylene glycol dimethyl ether (TEGME), polyethylene glycol dimethyl ether (PEGDME);
glycol ether esters, such as ethylene glycol methyl ether acetate, ethylene glycol monoethyl ether acetate, ethylene glycol monobutyl ether acetate; In a preferred embodiment, the non-fluorinated ether compound according to the present invention comprises dimethoxyethane (DME), 1,3-dioxolane (DOL), dibutyl ether, tetraethylene glycol dimethyl ether (TEGME), diethylene glycol dimethyl ether (DEGME), diethylene glycol diethyl ether (DEGDEE), polyethylene glycol dimethyl ether (PEGDME), 2-methyltetrahydrofuran and tetrahydrofuran (THF).

In a more preferred embodiment, the non-fluorinated ether compound is a mixture of DME and DOL.

In a even more preferred embodiment, the non-fluorinated ether compound is DME.

In one embodiment, the solvent mixture according to the present invention comprises
from 60 to 90 vol % of i) the fluorinated ether compound; and
from 10 to 40 vol % of ii) the non-fluorinated ether compound, with respect to the total volume of the solvent mixture.

In another embodiment, the solvent mixture according to the present invention comprises
from 80 to 90 vol % of i) the fluorinated ether compound; and
from 10 to 20 vol % of ii) the non-fluorinated ether compound, based on the total volume of the solvent mixture.

In one particular embodiment, the liquid electrolyte according to the present invention comprises:
80 vol % of i) the fluorinated ether compound containing 6 carbon atoms;
20 vol % of ii) the non-fluorinated ether comp, based on the total volume of solvent mixture; and
1 M of LiFSI dissolved in the solvent mixture.

In another particular embodiment, the liquid electrolyte according to the present invention comprises:
80 vol % of i) the fluorinated ether compound containing 6 carbon atoms;
20 vol % of ii) the non-fluorinated ether comp, based on the total volume of solvent mixture; and
2 M of LiFSI dissolved in the solvent mixture.

In one more particular embodiment, the solvent mixture comprises 80 vol % of TTE and 20 vol % of DME, with respect to the total volume of the solvent mixture.

In another more particular embodiment, the solvent mixture comprises 80 vol % of CF₂HCF₂—OCH₂CH₂O—CF₂CF₂H and 20 vol % of DME, with respect to the total volume of the solvent mixture.

In one embodiment, the metal salt is at least one lithium salt selected from the group consisting of lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPF_{X}(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CnF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂C_{q}F_{2q+1}) wherein p=1-10 and q=1-10, lithium salts of chelated orthoborates and chelated orthophosphates such as lithium bis(oxalato)borate [LiB(C₂O₄)₂], lithium bis(malonato)borate [LiB(O₂CCH₂CO₂)₂], lithium bis(difluoromalonato) borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato) phosphate [LiP(O₂CCF₂CO₂)₃], lithium difluorophosphate (LiPO₂F₂), lithium 2-trifluoromethyl-4,5-dicyanoimidazole (LiTDI) or mixtures thereof. In a preferred embodiment, the lithium salt is LiFSI.

In one embodiment, a molar concentration (M) of the lithium salt in the liquid electrolyte according to the present invention is from 1 M to 8 M, preferably from 1 M to 3 M, and more preferably from 1 M to 2 M.

The secondary battery according to the present invention may further comprise a separator.

By the term “separator”, it is hereby intended to denote a monolayer or multilayer polymeric, nonwoven cellulose or ceramic material/film, which electrically and physically separates the electrodes of opposite polarities in an electrochemical device and is permeable to ions flowing between them.

In the present invention, the separator can be any porous substrate commonly used for a separator in an electrochemical device.

In one embodiment, the separator is a porous polymeric material comprising at least one material selected from the group consisting of polyester such as polyethylene terephthalate and polybutylene terephthalate, polyphenylene sulphide, polyacetal, polyamide, polycarbonate, polyimide, polyether sulfone, polyphenylene oxide, polyphenylene sulfide, polyethylene naphthalene, polyethylene oxide, polyacrylonitrile, polyolefin such as polyethylene and polypropylene, or mixtures thereof.

In a particular embodiment, the separator is a porous polymeric material coated with inorganic nanoparticles, for instance, SiO₂, TiO₂, Al₂O₃, ZrO₂, etc.

In another particular embodiment, the separator is a porous polymeric material coated with polyvinylidene difluoride (PVDF).

In a particular embodiment, c) the liquid electrolyte further comprises at least one additive, in particular a film-forming additive, which promotes the formation of the solid electrolyte interface (SEI) layer at the anode surface and/or cathode surface by reacting in advance of the solvents on the electrode surfaces. The main components of SEI hence comprise the decomposed products of electrolyte solvents and salts, which include Li₂CO₃, lithium alkyl carbonate, lithium alkyl oxide and other salt moieties such as LiF for LiPF₆-based electrolytes. Usually, the reduction potential of the film-forming additive is higher than that of the solvent when reaction occurs at the anode surface, and the oxidation potential of the film-forming additive is lower than that of the solvent when the reaction occurs at the cathode side.

In another embodiment, the film-forming additive according to the present invention is selected from the group consisting of cyclic sulfite and sulfate compounds comprising 1,3-propanesultone (PS), ethylene sulfite (ES) and prop-1-ene-1,3-sultone (PES); sulfone derivatives comprising dimethyl sulfone, tetramethylene sulfone (also known as sulfolane), ethyl methyl sulfone and isopropyl methyl sulfone; nitrile derivatives comprising succinonitrile, adiponitrile, glutaronitrile, and 4,4,4-trifluoronitrile; lithium nitrate (LiNO₃); boron derivatives salt comprising lithium difluoro oxalato borate (LiDFOB), lithium fluoromalonato (difluoro)borate (LiFMDFB), vinyl acetate, biphenyl benzene, isopropyl benzene, hexafluorobenzene, tris(trimethylsilyl)phosphate, triphenyl phosphine, ethyl diphenylphosphinite, triethyl phosphite, tris(2,2,2-trifluoroethyl) phosphite, maleic anhydride, vinylene carbonate, vinyl ethylene carbonate, mono-fluorinated ethylene carbonate (4-fluoro-1,3-dioxolan-2-one), difluorinated ethylene carbonate, cesium bis(trifluorosulfonyl)imide (CsTFSI) and cesium fluoride (CsF), and mixtures thereof.

In one preferred embodiment, the film-forming additive according to the present invention is vinylene carbonate.

In the present invention, the total amount of the film-forming additive(s) may be from 0 to 30 wt %, preferably from 0 to 20 wt %, more preferably from 0 to 15 wt %, and even more preferably from 0 to 5 wt % with respect to the total weight of c) the liquid electrolyte.

The total amount of the film-forming additive(s), if contained in the liquid electrolyte solution of the present invention, may be from 0.05 to 10.0 wt %, preferably from 0.05 to 5.0 wt %, and more preferably from 0.05 to 2.0 wt % with respect to the total weight of c) the liquid electrolyte.

In a preferred embodiment, the total amount of film-forming additive(s) accounts for at least 1.0 wt % of c) the liquid electrolyte.

The present invention also relates to use of a (per)fluoroelastomer as a protective layer for a negative electrode comprising an alkali metal in a secondary battery, wherein the secondary battery comprises a solvent mixture comprising i) at least one fluorinated ether compound and ii) at least one non-fluorinated ether compound.

In a preferred embodiment, the (per)fluoroelastomer is a terpolymer of vinylidene fluoride (VDF), hexafluoropropene (HFP) and tetrafluoroethylene (TFE) in the molar ratio range of 50-80:15-25:2-25.

In another preferred embodiment, the solvent mixture comprises
from 60 to 90 vol %, preferably from 80 to 90 vol % of i) the fluorinated ether compound; and
from 10 to 40 vol %, preferably from 10 to 20 vol % of ii) the non-fluorinated ether compound, with respect to the total volume of the solvent mixture.

In one particular embodiment, the solvent mixture comprises 80 vol % of TTE and 20 vol % of DME, with respect to the total volume of the solvent mixture.

In another particular embodiment, the solvent mixture comprises 80 vol % of CF₂HCF₂—OCH₂CH₂O—CF₂CF₂H and 20 vol % of DME, with respect to the total volume of the solvent mixture.

Should the disclosure of any patents, patent applications, and publications which are incorporated herein by reference conflict with the description of the present application to the extent that it may render a term unclear, the present description shall take precedence.

The invention will be now explained in more detail with reference to the following examples, whose purpose is merely illustrative and not intended to limit the scope of the invention.

### Examples

### Raw Materials

TTE: a fluorinated ether compound of 1,1,2,2-tetrafluoroethyl-2,2,3,3-tetrafluoropropyl ether having a boiling point of about 93° C., commercially available from ChemFish.
TFEE: a fluorinated ether of 1,2-bis(1,1,2,2-tetrafluoroethoxy)ethane, i.e., CF₂HCF₂—OCH₂CH₂O—CF₂CF₂H having a boiling point of about 160° C., synthesized within Solvay
DME: 1,2-dimethoxyethane, commercially available from Sigma-Aldrich
Fluoroelastomer A: TECNOFLON®TN (VDF-HFP-TFE), available from Solvay Specialty Polymers Italy S.p.A
Fluoroelastomer B: TECNOFLON®HS(LX) (VDF-HFP), available from Solvay Specialty Polymers Italy S.p.A
Li salt: lithium bis(fluorosulfonyl)imide (LiFSI), commercially available from Nippon Shokubai

### Thin Film Casting

### A/ Formulation of the Casting Solution

### 1—Tecnoflon® Formulation in Tetrahydrofuran (THF)

The casting solution was prepared by solubilizing from 2 to 5 wt % of TECNOFLON® resin in THE solvent. To prepare 50 g of solution at 3 wt % concentration, the mixing was implemented through the following procedure:
Dry TECNOFLON® in vacuum oven at 80° C. overnight (for about 16 hours).
In an Ar-filled glove-box, mix 1.5 g of TECNOFLON® and 48.5 g of THF (anhydrous grade) in a 50 ml vial.
Stir with magnetic stirrer until complete dissolution. Duration can vary depending on the polymer and solvent to be used. For TECNOFLON® in THF, 16 hours at 50° c. was applied.

In case a lithium salt was added, the lithium salt was used in 20 wt % concentration with respect to content of TECNOFLON®, and was added at the second step, before adding TECNOFLON® to ensure proper dissolution of the lithium salt.

### B/ Casting Procedure

To prepare a layer of about 2 m thickness, a Doctor-Blade device was used in an Ar-filled glove-box through the following procedure:
First, a sheet of paper, free of oxygen and moisture, was placed on the vacuum table of the Doctor Blade, while all the surfaces must be covered.
Place the anode substrate, completely flat, above the paper sheet.
Set the thickness of the blade to 100 m thick and the thickness of the substrate to 30 m (for Li/Cu substrate).
Place the blade across the substrate.
Set the pushing bar at low speed; drop the polymer solution along the right edge of the substrate, and rapidly proceed to casting.
Clean the blade and remove the excess of solution.

Once casted, the film was dried at temperature between 65 and 90° C. for one hour in the Ar-filled glove-box. The protected negative electrode was further incorporated into a coin cell for battery performance testing.

### C/ Electrolyte Formulation:

### Localized High Concentration Electrolyte (LHCE)

The electrolyte was prepared by a simple mixing method using magnetic stirrer under the glovebox. LiFSI was used as a lithium salt and the DME was used as the main solvent. To optimize formulations, the LiF SI was first dissolved in the DME and was mixed until becoming a transparent solution. After checking the clear solution, the fluorinated ether solvent was mixed as a diluent to reach out to the 1 M concentration.

### Battery Performance Test

### A/ Preparation of Li Metal Cells:

The LCO positive electrodes were purchased from Li-Fun Technology Corporation Limited, as single side-coated electrode (16 mg/cm²; unpressed; with 200 mm of width). Li/Cu negative electrodes were purchased from Honjo chemicals. The electrolyte was formulated based on DME and TTE. A standard Tonen-based membrane (20 μm thick polyolefin) was used as a separator. Coin cell casings and spacers were purchased from Hohsen, Japan (CR2032 types, in SS316 stainless steel).

All elements of the battery were dried for 24 hours in a vacuum chamber or in Ar-filled glove-box, before being incorporated or mixed. Solvents of the electrolyte and of the casting formulation were dried using molecular sieves for 24 hours.

### B/ Coin Cell Mounting Procedure

A full cell was prepared by assembling all parts successively in an Ar-filled glove-box, while making sure that every component was precisely centered. Subsequently, the liquid electrolyte was dropped twice, i.e., first in 70 μl on the negative electrode side and second in 70 μl on the surface of the separator, and then closed the cell with the dedicated device by applying about 1000 psi pressure. The cell was left as such for 10 minutes before running the electrochemical performance analysis.

### C/ Measurement of Battery Performance

The full cell was tested by using Biologic BCS-805 equipped with a cell holder, placed within a climatic chamber regulated at 20° C. The electrochemical impedance spectroscopy (EIS) analysis was run at the beginning of the cycles (before formation cycles), after the 3 formation cycles, and at the end of the test, respectively. Number of cycles at 80% of capacity were measured.

The inventive examples of E1-E2 were produced with 1M LiFSI in DME/TTE or DME/TFEE solvent mixture, where Fluoroelastomer A or Fluoroelastomer B was incorporated to be used for a protective layer on a surface of lithium metal as shown in Table 1 below.

As comparative examples, CE1-CE2 were prepared with 1M LiFSI in DME/TTE or DME/TFEE solvent mixture, in the absence of a fluoroelastomer, also as shown in Table 1.

TABLE 1

| | | | | Number of |
|---|---|---|---|---|
| | Li | Solvent | | cycles at 80% |
| | salt | (mixture) | Fluoropolymer | of capacity |
| E1 | 1M LiFSI | DME/TTE (20/80)* | Fluoroelastomer A | 180 |
| E2 | 1M LiFSI | DME/TFEE (20/80)* | Fluoroelastomer B | 195 |
| CE1 | 1M LiFSI | DME/TTE (20/80)* | None | 160 |
| CE2 | 1M LiFSI | DME/TFEE (20/80)* | None | 170 |

*wt. % with respect to the total weight of the solvent mixture

The inventive examples E1-E2 showed improved capacity retention (number of cycles at 80% of capacity), while CE1 and CE2 without fluoroelastomer exhibited lower capacity retention.

1. A secondary battery, comprising:
a) a negative electrode comprising an alkali metal;
b) a protective layer on a surface of the negative electrode; and
c) a liquid electrolyte comprising a solvent mixture and at least one metal salt,
wherein the protective layer comprises at least one (per)fluoroelastomer, and the solvent mixture comprises i) at least one fluorinated ether compound and ii) at least one non-fluorinated ether compound.

2. The secondary battery according to claim 1, wherein the alkali metal is lithium metal.

3. The secondary battery according to claim 1, wherein said (per)fluoroelastomer is a vinylidene-fluoride based fluoroelastomer comprising recurring units derived from vinylidene fluoride (VDF) and from at least one additional (per)fluorinated monomer different from VDF.

4. The secondary battery according to claim 3, wherein said at least one additional (per)fluorinated monomer different from VDF is selected in the group comprising:
C₂-C₈ perfluoroolefins;
hydrogen-containing C₂-C₈ olefins different from VDF;
C₂-C₈ chloro and/or bromo and/or iodo-fluoroolefins;
(per)fluoroalkylvinylethers (PAVE) of formula CF₂=CFOR_{f}, wherein R_{f} is a C₁-C₆ (per)fluoroalkyl group;
(per)fluoro-oxy-alkylvinylethers of formula CF₂=CFOX, wherein X is a C₁-C₁₂ ((per)fluoro)-oxyalkyl comprising catenary oxygen atoms;
(per)fluorodioxoles having formula: 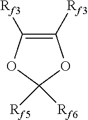
wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom;
(per)fluoro-methoxy-vinylethers (MOVE, hereinafter) having formula:
CFX₂=CX₂OCF₂OR″_{f},
wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂=F, H.

5. The secondary battery according to claim 3, wherein said (per)fluoroelastomer further comprises
at least one recurring unit derived from at least one hydrogenated monomer; and/or
at least one recurring unit derived from at least one bis-olefin [bis-olefin (OF)] having general formula: 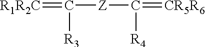
wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical.

6. The secondary battery according to claim 1, wherein said (per)fluoroelastomer is a terpolymer of vinylidene difluoride (VDF), hexafluoropropene (HFP) and tetrafluoroethylene (TFE), in a molar ratio range of 50-80:15-25:5-25.

7. The secondary battery according to claim 1, wherein i) the fluorinated ether compound has a chemical formula of CₐF_{b}H_{c}O_{d}, wherein a, b, c and d are all integers, d is an integer from 1 to 3, a is an integer from 3 to 10, and 2*(a+1)=b+c.

8. The secondary battery according to claim 1, wherein i) the fluorinated ether compound comprises 1,1,2,2-tetrafluoroethyl-2,2,3,3-tetrafluoropropyl ether (TTE) and/or CF₂HCF₂—OCH₂CH₂O—CF₂CF₂H.

9. The secondary battery according to claim 1, wherein ii) the non-fluorinated ether compound comprises dimethoxyethane (DME), 1,3-dioxolane (DOL), dibutyl ether, tetraethylene glycol dimethyl ether (TEGME), diethylene glycol dimethyl ether (DEGME), diethylene glycol diethyl ether (DEGDEE), polyethylene glycol dimethyl ether (PEGDME), 2-methyltetrahydrofuran, and tetrahydrofuran (THF).

10. The secondary battery according to claim 1, wherein the solvent mixture comprises
from 60 to 90% by volume (vol %) of i) at least one fluorinated ether compound; and
from 10 to 40 vol % ii) at least one non-fluorinated ether compound, with respect to the total volume of the solvent mixture.

11. The secondary battery according to claim 1, wherein the metal salt is at least one lithium salt selected from the group consisting of lithium hexafluorophosphate (LiPF₆), lithium perchlorate (LiClO₄), lithium hexafluoroarsenate (LiAsF₆), lithium hexafluoroantimonate (LiSbF₆), lithium hexafluorotantalate (LiTaF₆), lithium tetrachloroaluminate (LiAlCl₄), lithium tetrafluoroborate (LiBF₄), lithium chloroborate (Li₂B₁₀Cl₁₀), lithium fluoroborate (Li₂B₁₀F₁₀), Li₂B₁₂FₓH₁₂₋ₓ wherein x=0-12, LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂] wherein X is selected from the group consisting of H, F, Cl, C₁-C₄ alkyl groups and fluorinated alkyl groups, and n=0-4, lithium trifluoromethane sulfonate (LiCF₃SO₃), lithium bis(fluorosulfonyl)imide Li(FSO₂)₂N (LiFSI), LiN(SO₂CₘF₂ₘ₊₁)(SO₂CₙF₂ₙ₊₁) and LiC(SO₂CₖF₂ₖ₊₁)(SO₂CₘF₂ₘ₊₁)(SO₂CₙF₂ₙ₊₁) wherein k=1-10, m=1-10 and n=1-10, LiN(SO₂CₚF₂ₚSO₂) and LiC(SO₂CₚF₂ₚSO₂)(SO₂CF_{2q+1}) wherein p=1-10 and q=1-10, lithium salts of chelated orthoborates and chelated orthophosphates including lithium bis(oxalato)borate [LiB(C₂O₄)₂], lithium bis(malonato)borate [LiB(O₂CCH₂CO₂)₂], lithium bis(difluoromalonato) borate [LiB(O₂CCF₂CO₂)₂], lithium (malonatooxalato) borate [LiB(C₂O₄)(O₂CCH₂CO₂)], lithium (difluoromalonatooxalato) borate [LiB(C₂O₄)(O₂CCF₂CO₂)], lithium tris(oxalato) phosphate [LiP(C₂O₄)₃], lithium tris(difluoromalonato) phosphate [LiP(O₂CCF₂CO₂)₃], lithium difluorophosphate (LiPO₂F₂), lithium 2-trifluoromethyl-4,5-dicyanoimidazole (LiTDI) or mixtures thereof.

12. The secondary battery according to claim 1, further comprising a positive electrode, wherein the positive electrode comprises a positive electro-active material layer selected from the group consisting of lithium-nickel-manganese-cobalt-based metal oxide of formula LiNiₓMn_{y}Co_{z}O₂ (x+y+z=1), lithium-nickel-cobalt-aluminum-based metal oxide of formula LiNiₓCo_{y}Al_{z}O₂ (x+y+z=1), lithium-cobalt-based metal oxide, and lithium-nickel-manganese-based metal oxide (LNMO).

13. A method comprising providing a protective layer for a negative electrode, wherein the protective layer comprises a (per)fluoroelastomer comprising an alkali metal in a secondary battery, wherein the secondary battery comprises a solvent mixture comprising i) at least one fluorinated ether compound and ii) at least one non-fluorinated ether compound.

14. The method of claim 13, wherein the (per)fluoroelastomer is a terpolymer of VDF, HFP and TFE in the molar ratio range of 50-80:15:25:5-25.

15. The method of claim 13, wherein the solvent mixture comprises
from 60 to 90 vol %, preferably from 80 to 90 vol % of i) at least one fluorinated ether compound; and
from 10 to 40 vol % of ii) at least one non-fluorinated ether compound, with respect to the total volume of the solvent mixture.
